(19) United States
(12) Patent Application Publication
(10) Pub. No.: US 2014/0282985 A1
(43) Pub. Date: Sep. 18, 2014

(54) Remote Access Authentication

(71) Applicant: Google Inc., Mountain View, CA (US)

(72) Inventors: John Navil Joseph, Mountain View, CA (US); Brian Taewon Park, Mountain View, CA (US)

(73) Assignee: Google Inc., Mountain View, CA (US)

(21) Appl. No.: 13/839,635

(22) Filed: Mar. 15, 2013

(51) Int. Cl. G06F 21/34; G06F 21/35

(52) U.S. Cl. CPC G06F 21/34; G06F 21/35
USPC 726/9

(57) ABSTRACT

An electronic device may be used to authenticate a user when accessing a remote system. In this regard, authentication information required to authorize accessing the remote system may be stored securely on a secure device, with the authentication information being configured such that it is inaccessible or unreadable while in the electronic device. The electronic device may obtain (e.g., read) the authentication information from the secure device when attempting to access the remote system. Obtaining (e.g., reading) the authentication information from the secure device may be triggered based on (i.e., in response to) a challenge by the remote system. The electronic device may then communicate the authentication information to the remote system, which may be configured to determine whether to grant or deny access to the user based on the authentication information.

### TECHNICAL FIELD

Aspects of the present application relate to distribution of content. More specifically, certain implementations of the present disclosure relate to remote access authentication.

### BACKGROUND

Various types of electronic devices are commonly used nowadays. In this regard, electronic devices may be used by one or more users, for various purposes, including both personal and commercial. Electronic devices may be mobile or non-mobile, may support communication (wired and/or wireless), and/or may be general or special purpose devices. Examples of electronic devices comprise handheld mobile devices (e.g., cellular phones, smartphones, and/or tablets), computers (e.g., laptops, desktops, and/or servers), and/or other similar devices. The electronic devices may be utilized in accessing data or content, which may sometimes be stored or maintained remotely (in other systems or devices that may be accessed by the electronic devices), and/or retrieved therefrom, such as in the form of web access. In some instances, it may be desirable to protect data accessed and/or used by the electronic devices (e.g., when the data comprise confidential and valuable information). Therefore, guarding against unwanted access to information via the electronic devices is becoming more and more important.

Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for remote access authentication, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 is a block diagram illustrating an example of interactions for authenticating a user during remote access using an electronic device and a secure device.

FIG. 2 is a block diagram illustrating an electronic device that may support user authentication during remote access using secure devices.

FIG. 3 is a flow chart that illustrates example client-side process for user authentication during remote access using secure devices.

FIG. 4 is a flow chart that illustrates example server-side process for user authentication during remote access using secure devices.

### DETAILED DESCRIPTION

The present disclosure relates to a method and system for remote access authentication. In various implementations, a secure device may be used in conjunction with an electronic device to provide secure access, via the electronic device, to protected data. In this regard, the electronic device may obtain from the secure device, authentication information associated with a user, wherein the authentication information is stored in the secure device, and the authentication information is configured such that it is inaccessible or unreadable while in the electronic device. The electronic device may then communicate the obtained authentication information to a remote system that may be configured to determine whether to grant or deny access to the user based on the authentication information. The electronic device may communicate the authentication information to the remote system responsive to an authentication challenge issued by the remote system, such as when the user attempts to gain access to the remote system using the electronic device. The authentication information may be stored and/or outputted by the secured device as encrypted data, to ensure that it is inaccessible or unreadable while in the electronic device. The access that is granted or denied by the remote system comprises access to a protected website or webpage. The secure device may comprise a secure element, or other secure element like devices (e.g., Trusted Execution Environment (TEE) based elements).

The electronic device may obtain the authentication information from the secure device using a connection between the electronic device and the secure device. In this regard, the connection may comprise a near-field communication (NFC) connection or a wireless personal area network (WPAN) connection (e.g., Bluetooth, ZigBee or the like). The electronic device may obtain the authentication information from the secure device based on direct contact between the secure device and the electronic device. The secure device may be integrated and/or incorporated into the electronic device. The secure device may be configured to run independently of the electronic device, including when it is integrated and/or incorporated into the electronic device. The authentication information may be stored or configured into the secure device by the user, and/or by a remote security manager using a secure channel connecting directly to the secure device.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “exemplary” means serving as a non-limiting example, instance, or illustration. As utilized herein, the term “e.g.,” introduces a list of one or more non-limiting examples, instances, or illustrations.

FIG. 1 is a block diagram illustrating an example of interactions for authenticating a user during remote access using an electronic device and a secure device. Referring to FIG. 1 there is shown an electronic device, a remote server 110, and a secure device 130.

The electronic device 100 may comprise suitable circuitry, interfaces, logic, and/or code for performing, executing or running various operations, functions, applications and/or services. In this regard, the electronic device 100 may perform, execute and/or run operations, functions, applications and/or services based on user instructions and/or pre-configured instructions. Thus, the electronic device 100 may be configure to support or enable (e.g., by use of suitable input/output devices or components) interactions with users, such as to obtain user input and/or to provide user output. In some instances, the electronic device 100 may support communication of data, such as via wired and/or wireless connections, in accordance with one or more supported wireless and/or wired protocols or standards. In some instances, the electronic device 100 may be a handheld mobile device—i.e. intended for use on the move and/or at different locations. In this regard, the electronic device 100 may be designed and/or configured to allow for ease of movement, such as to allow it to be readily moved while being held by the user as the user moves, and the electronic device 100 may be configured to perform at least some of the operations, functions, applications and/or services supported by the device on the move. Examples of electronic devices may comprise handheld devices (e.g., cellular phones, smartphones, and/or tablets), computers (e.g., laptops or desktops), servers, dedicated multimedia devices (e.g., game consoles and portable media players), and/or other similar devices. The disclosure, however, is not limited to any particular type of electronic device.

The remote server 110 may comprise suitable circuitry, interfaces, logic, and/or code for providing services and/or data to a plurality of electronic devices, such as the electronic device 100. In this regard, the remote server 110 may be configured to support remote access by electronic devices and/or users associated therewith. For example, the remote server 110 may be utilized to support storage and/or retrieval of data that may be accessed and/or used by electronic devices, such as the electronic device 100. Accessing data (or other content) available via the remote server 100 may be done in various manners. For example, the remote server 110 may be configured to support remote access (e.g., by electronic device 100), such as in the form of web or online based access. In this regard, the data available in or offered by the remote server 110 may be provided in the form of web content that can be accessed through the Internet, such as using HTTP (Hypertext Transport Protocol) protocol or any other suitable protocol. The remote server 110 may comprise a dedicated processing system or general purpose system (e.g., a dedicated server or a PC), which may be configured for use as centralized content manager (e.g., programmed to provide the application management functions described in this disclosure). In some instances, a remote ‘server’ may actually comprise a plurality of machines, at least some of which may be installed in different locations, and each of which may be utilized to implement distinct or redundant functions associated with application management operations as described in the present disclosure.

In operation, the electronic device 100 may be utilized (e.g., by a device user) to perform, execute and/or run various functions, applications or services, such as using pre-configured instructions and/or based on real-time user instructions or interactions. In this regard, various types of operations, functions, applications or services may be available in or supported by the electronic device 100. For example, the electronic device 100 may be used for playing video and/or audio content, gaming, email applications (and/or similar type of web based communications), calling services (e.g., voice calls), and/or network services (e.g., WiFi hotspot, Bluetooth piconet, and/or active 3G/4G/femtocell data channels). The electronic device 100 may sometimes be used to access and/or use data, which may be retrieved from remote systems or devices (e.g., the remote server 110). In this regard, accessing data (or other content) available via the remote server 100 may be done in various manners, including, for example, using web based or online based access. For example, the remote server 110 may function and/or be configured as a web server, such as to enable delivery of data in the form of web content that can be accessed through, for example, the Internet. In other words, accessing data and/or content available in the remote server 110 by the electronic device 100 may be web based—e.g., the data may be accessed in form of accessing websites and/or webpages, such as using available and/or suitable web browsers in the electronic device 100.

In some instances, it may be desirable to limit and/or control access to particular data or content in the remote server 110, such as when electronic devices (e.g., the electronic device 100) are utilized to access and/or utilize data associated with particular user(s). For example, certain data or content may be copyrighted (thus requiring limiting its access or use to only authorized users), may comprise confidential information (e.g., personal or financial information), or the like. Accordingly, the remote server 110 and the electronic devices may be configured to implement various measures to guard against and/or prevent unwanted access. For example, accessing data or content retrieved from the remote server 110 may be subject to user authentication before access to the data or content is allowed—i.e., the user requesting access to the data or content must first be authentication before such access is granted. This may be achieved, for example, by requiring users seeking access to particular data or content to provide information that may sufficiently allow validating or authenticating them. For example, users may be required to provide predetermined credentials establishing or verifying their identities as part of a login process to gain access to a website or webpage as means for retrieving particular data or content from remote systems. In this regard, such credentials may be known only to the authorized user(s), and as such only legitimate users may be able to provide these credentials (e.g., as part of a login process) to obtain access to desired websites or webpages. Because of heightened security concerns, credential utilized in users authentications have become increasingly complex and/or long, making it difficult for users to always remember that information correctly and/or making it inconvenient to provide (e.g., enter) that information whenever access to protected data/content is desired. Accordingly, in various implementations of the disclosure, dedicated secure components or devices may be used and/or configured to allow expedited and/or convenient access support. In this regard, at least some of information (e.g. credentials and/or data that may be used in generating credentials) and/or processes that may be used during secure access operations may be pre-stored and/or pre-configured into dedicated secure components or devices, which may function so that it may provide the necessary information or processes when needed (e.g., in conjunction with use of electronic device) while remaining independent to guard against unwanted access of the actual information or processes while enabling secure access via the electronic device. In other words, the secure components, which may be integrated into the electronic device or made into separate devices, may be operable to provide information or functions necessary to authenticate particular user(s) that are utilizing the electronic devices to gain access to protected data such that the information or processes may remain protected from being accessed or read through the electronic devices.

In an example implementation, for example, credentials required for allowing particular user(s) to login to particular website(s) or webpage(s) may be stored securely on a secure device 130, which may comprise a secure element for example. The disclosure is not so limited, however, and other secure element like devices may be used, such as devices comprising Trusted Execution Environment (TEE) based processor. The secure device 130 may be incorporated into the electronic device 100 or may be configured as a separate, dedicated device that may maintained by user 120 of the electronic device 100. In an example access process, an access request may be initiated (1), and sent to the remote server 110. For example, the access request may be initiated directly (e.g., by the user 120), such as by specifying particular data (e.g., webpage) that may be desired, or indirectly (e.g., by initiating a particular application or function that trigger a corresponding data access). The remote server 110 may then determine that the access (or data whose access is requested) is protected and/or is subject to access limitation. The remote server 110 may then apply secure access validation, such as based on a challenge-response mechanism. In this regard, the remote server 110 may send (2) to the electronic device 100, in response to the access request, an authentication challenge. The authentication challenge may require the electronic device 100 to respond (i.e., by send back a challenge response) comprising particular information that may enable authenticating the requesting device and/or user (e.g., credentials).

The electronic device 100 may then obtain (3) the necessary authentication information needed for the challenge response. In this regard, the necessary authentication information, for the challenge response, may be provided to the electronic device by the secure device 130 (e.g., secure element). Obtaining the authentication information may be by various means, such as using connection between the secure device 130 and the electronic device 100, which may be established to allow forwarding the challenge information to the secure device 130 and/or to obtain the necessary authentication information therefrom. For example, interactions between the devices may be by use of near field communication (NFC), such as by tapping the secure device (element) 130 onto the electronic device 100 for example. The necessary authentication information may simply be pre-stored and/or pre-configured into the secure device 130, and may simply be read out of it when needed. Alternatively, the authentication information may be generated dynamically (e.g., calculated) during each challenge-response interaction, such as based on information included in the challenge received from the remote system (e.g., the remote sever 110) and/or based on pre-configured information (e.g., user specific credentials) stored in the secure device 130. For example, the secure device (element) 130 may compute the information (authentication information) used in the challenge response internally and respond back to the electronic device 100 (e.g., to a web browser being used in conjunction with the attempted access), which may then respond back to the web server. For added security, and to further guard against unwanted access, suitable measures may be used to ensure that the authentication information remains inaccessible and/or unreadable while in the electronic device 100 and/or while being communicated thereby. For example, the authentication information may be encrypted. In this regard, the authentication information may be pre-stored in an encrypted state or be encrypted dynamically (e.g., when generated dynamically by the secure device 130).

In some instances, the secure device 130, or other components or devices (e.g., the electronic device 100) may prompt the user 120 to provide certain information (e.g., enter preconfigured password, passphrase, PIN—that is “Personal Identification Number,” or the like) to authorize the secure device 130 to respond back with the authentication information It some instances, the secure device 130 may be configured to selectively choose whether to respond with the pre-stored information or with challenge response (i.e. simply output the credential or calculate the challenge response using the credential and/or data in the challenge). For example, the user may configure the credential into the secure device 130, and the secure device 130 may then require some sort of user validation (e.g., finger print scanning) and confirmation before the credentials are stored. The secure Device 130 may then be configured to respond with the challenge response based on particular criteria (e.g., being tapped or touched in some specific pattern, known only to the user).

Once the authentication information is obtained or read from the secure device 130, the electronic device 100 may send (4) the authentication (challenge) response back to the remote server 110. The remote server 110 may then determine (5) whether to grant the requested access or deny it based on the authentication data. In this regard, the remote server 110 may process the authentication information (including decrypting it if needed—i.e., if encrypted), and may analyze the information to determine if requested access should be granted or denied, such as by comparing it with pre-defined credentials of authorized users.

FIG. 2 is a block diagram illustrating an electronic device that may support user authentication during remote access using secure devices. Referring to FIG. 2 there is shown an electronic device 200. Also shown in FIG. 2 is a secure device 250.

The electronic device 200 may comprise suitable circuitry, interfaces, logic, and/or code for implementing various aspects of the disclosure. In this regard, the electronic device 200 may correspond to, for example, the electronic device 100 of FIG. 1. The electronic device 200 may comprise, for example, a main processor 202, a system memory 204, a communication subsystem 210, an input/output (I/O) subsystem 220, a secure access manager 230, and a secure device 250.

The main processor 202 may comprise suitable circuitry, interfaces, logic, and/or code that may be operable to process data, and/or control and/or manage operations of the electronic device 200, and/or tasks and/or applications performed therein. In this regard, the main processor 202 may configure and/or control operations of various components and/or subsystems of the electronic device 200, by utilizing, for example, one or more control signals. The main processor 202 may enable running and/or execution of applications, programs and/or code, which may be stored, for example, in the system memory 204. Alternatively, one or more dedicated application processors may be utilized for running and/or executing applications (or programs) in the electronic device 200.

The system memory 204 may comprise suitable circuitry, interfaces, logic, and/or code that may enable permanent and/or non-permanent storage, buffering, and/or fetching of data, code and/or other information, which may be used, consumed, and/or processed. In this regard, the system memory 204 may comprise different memory technologies, including, for example, read-only memory (ROM), random access memory (RAM), Flash memory, solid-state drive (SSD), and/or field-programmable gate array (FPGA). The system memory 204 may store, for example, configuration data, which may comprise parameters and/or code, comprising software and/or firmware.

The communication subsystem 210 may comprise suitable circuitry, interfaces, logic, and/or code operable to communicate data from and/or to the electronic device, such as via one or more wired and/or wireless connections. The communication subsystem 210 may be configured to support one or more wired protocols and/or interfaces, and/or one or more wireless protocols and/or interfaces, facilitating transmission and/or reception of signals to and/or from the electronic device 200 and/or processing of transmitted or received signals in accordance with applicable wired or wireless protocols. Examples of wireless protocols or standards that may be supported and/or used by the communication subsystem 210 comprise wireless personal area network (WPAN) protocols, such as Bluetooth (IEEE 802.15); near field communication (NFC) standards; wireless local area network (WLAN) protocols, such as WiFi (IEEE 802.11); cellular standards, such as 2G/2G+(e.g., GSM/GPRS/EDGE, and IS-95 or cdmaOne) and/or 3G/3G+ (e.g., CDMA2000, UMTS, and HSPA); 4G standards, such as WiMAX (IEEE 802.16) and LTE; Ultra-Wideband (UWB), and/or the like. Examples of wired protocols and/or interfaces that may be supported and/or used by the communication subsystem 210 comprise Ethernet (IEEE 802.2), Fiber Distributed Data Interface (FDDI), Integrated Services Digital Network (ISDN), and Universal Serial Bus (USB) based interfaces. Examples of signal processing operations that may be performed by the communication subsystem 210 comprise, for example, filtering, amplification, analog-to-digital conversion and/or digital-to-analog conversion, up-conversion/down-conversion of baseband signals, encoding/decoding, encryption/decryption, and/or modulation/demodulation.

The I/O subsystem 220 may comprise suitable circuitry, interfaces, logic, and/or code for enabling and/or managing user interactions with the electronic device 200, such as obtaining input from and/or providing output to the device user(s). The I/O subsystem 220 may support various types of inputs and/or outputs, including, for example, video, audio, and/or text. In this regard, dedicated I/O devices and/or components, external to (and coupled with) or integrated within the electronic device 200, may be utilized for inputting and/or outputting data during operations of the I/O subsystem 220. Examples of such dedicated I/O devices may comprise displays, audio I/O components (e.g., speakers and/or microphones), mice, keyboards, touch screens (or touchpads), and the like. In some instances, user input obtained via the I/O subsystem 220, may be used to configure and/or modify various functions of particular components or subsystems of the electronic device 200.

The secure access manager 230 may comprise suitable circuitry, interfaces, logic, and/or code for managing secure access in the electronic device 200. In this regard, the secure access manager 230 may be configured to support and/or manage user authentication such as during secure access of remote systems or devices. In some instances, and for added measure of security, information used in authentication or other similar credential verification related operations may be maintained separate from, and/or inaccessible or readable by (or through) the electronic device 200. In this regard, while the secure access manager 230 may handle authentication related interactions involving the electronic device 200, the actual authentication related information may remain hidden from the secure access manager 230 (and the electronic device 230), such as by use of dedicated secure devices (e.g., the secure device 250) to maintain authentication related information and/or to perform various authentication related functions.

The secure device 250 may comprise suitable circuitry, interfaces, logic, and/or code for supporting secure access in the electronic device 200, particularly with respect to providing authentication or other credential related information during secure access of remote systems or devices and/or obtaining of data therefrom. The secure device 250 may be configured to support secure access of particular data or content via the electronic device 200, in a manner that may ensure protection of the authentication related information (e.g., while in the electronic device 200), as described with respect to FIG. 2. While the secure device 250 is shown as separate from the electronic device 200, the disclosure is not so limited—i.e., the secure device 250 may be implemented as (or integrated as) a component of the electronic device 200. Nonetheless, in this example embodiment, the secure device 250 is configured to run independently of the electronic device 250, in a manner to ensure that data maintained therein and/or functions performed thereby remain isolated from and/or inaccessible by (or through) the electronic device 200.

In an example implementation, the secure device 250 may comprise a secure element. In this regard, a secure element may comprise a dedicated chip, which may be attached to a peer device (e.g., the electronic device 200) using a suitable interface (e.g., near field communication (NFC) connections). A secure element may comprise an independent, typically very low powered processor (e.g., CPU) for allowing the secure element to run its own operating system (OS) separate from the peer device, and allowing for installation and running of separate software in an environment that is separate and different from the peer device itself. Accordingly, the use of an independent OS and software functions may allow for added security, making the secure element tamper proof and very difficult to access, which may be essential to guard credential related information or functions against unwanted access, particularly via the peer device.

In some instances, information provided by the secure device 250 may be encrypted to further ensure protection against unwanted access. Accordingly, the secure device 250 may be configured to incorporate and/or internally perform cryptographic encryption and decryption.

In some instances, the secure device 250 may be implemented without an internal power supply. In this regard, the secure device 250 may obtain power only when needed, such as from the device to which it attaches (connects). For example, when the secure device 250 comprises a secure element, it may be paired up with a NFC controller of the peer device, using an NFC reader. The NFC controller of the peer device may actually power the secure device 250, for example, by using electromagnetic induction from a magnetic field of the NFC reader. In this regard, the NFC reader may generate an electric current (e.g., in an antenna) in the peer device, and may send current into the secure device 250 to power it. The disclosure is not so limited, however, and in some instances, the secure device 250 may incorporate an internal power supply (e.g., battery).

In operation, the electronic device 200 may be utilized in conjunction with the secure device 250 to support secure access operations in the electronic device 200—i.e., access of protected data or content available from remote systems or devices, in a manner that ensures information or functions utilized in ensuring that access remain secure (including being inaccessible via the electronic device 200), substantially as described with respect to FIG. 1. For example, the electronic device 200 may receive, in response to an access request initiated via the electronic device 200 by a user thereof, an authentication challenge. In this regard, the authentication challenge may require the electronic device 200 to respond with a challenge response comprising particular information that may enable authenticating the electronic device 200 and/or the user initiating the access request, such as, for example, authentication information 252 (e.g., credential). The electronic device 200 may obtain the necessary authentication information 252 needed for the challenge response from the secure device 250. In this regard, reading 254 the authentication information 252 may be by various means, such as, for example, using a connection between the secure device 250 and the electronic device 200. The connection between the secure device 250 and the electronic device 200 may also be used to allow forwarding of the challenge (or of information included therein) received by the electronic device 200 to the secure device 250. For example, interactions between the devices may be by use of near field communication (NFC) connections or WPAN connections, which may established and/or controlled by the communication subsystem 210. The disclosure is not limited, however, to particular type of connections. The connection established between the devices may be based on physical contact, such as by tapping the secure device 250 onto the electronic device 200 for example (for NFC connectivity).

The authentication information 252 may be pre-stored and/or pre-configured into the secure device 250, and may be read out of it when needed (e.g., during challenge-response authentication). Alternatively, the authentication information 252 may be generated dynamically during each challenge-response interaction, such as based on information included in the received challenge. For example, the secure device 250 may compute the authentication information 252 challenge response internally, such as based on (at least in part) data included in the received challenge. In some instances, for added security and to further guard against unwanted access, suitable measures may be used to ensure that the authentication information 252 remain inaccessible and/or unreadable while in the electronic device 200 and/or being communicated thereby. For example, the authentication information 252 may be encrypted. In this regard, the authentication information 252 may be pre-stored in an encrypted state or be encrypted dynamically (e.g., when generated dynamically by the secure device 250). In some instances, the secure device 250, or other components or devices (e.g., the electronic device 200) may prompt the user 120 to provide certain information (e.g., enter preconfigured password, passphrase, PIN, or the like) to authorize the secure device 250 to respond back with the authentication information 252. Once the authentication information 252 is read 254 from the secure device 250, the electronic device 200 may respond to the challenge with a response that may comprise the authentication information 252, to enable the challenging remote system or device to determine whether to grant or deny access.

FIG. 3 is a flow chart that illustrates an example client-side process for user authentication during remote access using secure devices. Referring to FIG. 3, there is shown a flow chart 300 comprising a plurality of steps that may be performed at the client-side (e.g., using an electronic device and a secure device, such as the electronic device 200 and the secure device 250) for authenticating a user during remote access related operations.

In step 302, a user may initiate via the electronic device a remote access request. In this regard, the remote access request may be initiated directly, such as by specifically attempting to access data from a particular remote device/system (e.g., the remote server 110 of FIG. 1), or implicitly, such as by initiating actions or processes that may require accessing data that are determined to reside in (or be accessible through) the remote device/system. The remote access request may be communicated by the electronic device to the remote device/system. In step 304, the electronic device may receive an authentication request from the remote device/system (e.g., authentication challenge) in response to the remote access request. In step 306, the electronic device may notify the user of the authentication request, and may prompt the user to provide necessary information (e.g., from the secure device). In step 308, the electronic device may obtain authentication data from the secure device—e.g., by reading the authentication data from the secure device when there is a physical contact (e.g., using NFC connection) between the devices. In this regard, the challenge received from the remote device/system may be forwarded to the secure device, which may then respond with the authentication data, which may be computed based on the information included in the challenge. Furthermore, the data reading is configured such that data remains inaccessible and/or non-readable while in the electronic device. In step 310, the authentication data may be communicated to the remote device/system, and the user/electronic device wait for indication of access grant/denial.

FIG. 4 is a flow chart that illustrates an example server-side process for user authentication during remote access using secure devices. Referring to FIG. 4, there is shown a flow chart 400 comprising a plurality of steps that may be performed at the server-side (e.g., by a remote device or server that may be used in maintaining data, such as the server 110) for authenticating a user during remote access related operations.

In step 402, the remote device/system may receive a data access request, which may be sent by a user (e.g., using a user-end device, such as the electronic device 200). In this regard, the data access request may be triggered based on direct request (i.e. directly attempting to access data from the remote device/system) or indirectly (e.g., by initiating actions or processes that require accessing data). In step 404, it may be determined whether the requested data is subject to any access restriction (i.e. whether the data whose access is being request is available to any requester, or if there is any applicable access limitation and/or validation/authentication requirements). In instances where it is determined that the requested data is not subject to any access restriction, the process may proceed to step 406. In step 406, the access to requested data may be allowed or granted. In this regard, granting access to the requested data may comprise allowing access to the data on the remote device/system (e.g., allowing operations on the data, such as modifications, to be performed directly on the data in the remote device/system) or it may be by communicating copy of data to the requesting device/user).

Returning to step 404, in instances where it may be determined that the requested data is subject to access restriction, the process may proceed to step 408. In step 408, the remote device/system may apply necessary access validations (e.g., as configured). For example, the remote device/system may issue a challenge to the requesting device/user, which (the challenge) may require a response with particular response data. In various implementations of the disclosure, the challenge response data may comprise user-specific authentication data that have to be read from a separate secure device, such as in a manner that prevents the data from being read or accessed while it is in the electronic device that the user is utilizing in interacting with the remote device/system. In some instances, the challenge issued by the remote device/system may be subject to a time limit, such as by using a timer that may be (re)started whenever a challenged is issued or sent. The timer value may be configurable, such as to allow for a reasonable response time—e.g., being determined based on an estimation of maximum round-trip duration, plus some additional time corresponding to an estimated reasonable duration for interaction(s) by an authorized user when providing the necessary information. In such scenarios, a time out (e.g., based on timer expiry) check may be performed in step 410. In instances where a timeout may occur, the process may proceed to step 412. In step 412, access to the requested data may be denied. In this regard, in some instances the requesting device/user may be flagged, such as to allow rejecting any access attempt in the future.

Returning to step 410, in instances where a timeout does not occur (i.e., a response—e.g., to the challenge—is received from the requesting user/device), the process may proceed to step 414. In step 414, an authentication check (e.g., on data in received response) may be performed. In instances where the authentication check is successful, the process may proceed to step 406 (to allow access to the requested data), otherwise (i.e., if the authentication check fails) the process may proceed to step 412 (to deny access to the requested data).

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for remote access authentication.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method, comprising:
obtaining, by an electronic device from a secure device, authentication information associated with a user, wherein:
the authentication information is stored in the secure device, and
the authentication information is configured such that it is inaccessible or unreadable while in the electronic device; and
communicating, by the electronic device, the obtained authentication information to a remote system that is configured to determine whether to grant or deny access to the user based on the authentication information.

2. The method of claim 1, comprising communicating by the electronic device, the authentication information to the remote system responsive to an authentication challenge issued by the remote system when the user attempts to gain access to the remote system using the electronic device.

3. The method of claim 1, wherein the authentication information is stored and/or outputted by the secured device as encrypted data, to ensure that it is inaccessible or unreadable while in the electronic device.

4. The method of claim 1, wherein the access that is granted or denied by the remote system comprises access to protected website or webpage.

5. The method of claim 1, wherein the secure device comprises a secure element or a Trusted Execution Environment (TEE) based device.

6. The method of claim 1, comprising obtaining the authentication information from the secure device using a connection between the electronic device and the secure element.

7. The method of claim 6, wherein the connection comprises a near-field communication (NFC) connection or a wireless personal area network (WPAN) connection.

8. The method of claim 1, comprising obtaining the authentication information from the secure device based on direct contact between the secure device and the electronic device.

9. The method of claim 1, wherein the secure device is integrated and/or incorporated into the electronic device.

10. The method of claim 9, wherein the secure device runs independent of the electronic device when it is integrated and/or incorporated into the electronic device.

11. The method of claim 1, wherein the authentication information is stored or configured into the secure device by the user, and/or by a remote security manager using a secure channel connecting directly to the secure device.

12. A system, comprising:
an electronic device that is configured to support access of data by a user associated with the electronic device, the electronic device being operable to:
obtain from a secure device, authentication information associated with the user, wherein:
the authentication information is stored in the secure device, and
the authentication information is configured such that it is inaccessible or unreadable while in the electronic device; and
communicate the obtained authentication information to a remote system that is configured to determine whether to grant or deny access to the user based on the authentication information.

13. The system of claim 12, wherein the electronic device is operable to communicate the authentication information to the remote system responsive to an authentication challenge issued by the remote system when the user attempts to gain access to the remote system using the electronic device.

14. The system of claim 12, wherein the authentication information is stored and/or outputted by the secured device as encrypted data, to ensure that it is inaccessible or unreadable while in the electronic device.

15. The system of claim 12, wherein the access that is granted or denied by the remote system comprises access to protected website or webpage.

16. The system of claim 12, wherein the secure device comprises a secure element or a Trusted Execution Environment (TEE) based device.

17. The system of claim 12, wherein the electronic device is operable to obtain the authentication information from the secure device using a connection between the electronic device and the secure element.

18. The system of claim 17, wherein the connection comprises a near-field communication (NFC) connection or a wireless personal area network (WPAN) connection.

19. The system of claim 12, wherein the electronic device is operable to obtain the authentication information from the secure device based on direct contact between the secure device and the electronic device.

20. The system of claim 12, wherein the secure device is integrated and/or incorporated into the electronic device.

21. The system of claim 20, wherein the secure device runs independent of the electronic device when it is integrated and/or incorporated into the electronic device.

22. The system of claim 12, wherein the authentication information is stored or configured into the secure device by the user, and/or by a remote security manager using a secure channel connecting directly to the secure device.
